(19) United States
(12) Patent Application Publication
(10) Pub. No.: US 2019/0180309 A1
(43) Pub. Date: Jun. 13, 2019

(54) METHOD AND SYSTEM FOR OPTIMZING CUSTOMER ENGAGEMENT

(71) Applicant: ANI TECHNOLOGIES PRIVATE LIMITED, Bengaluru (IN)

(72) Inventors: Sai Akhil Suggu, Srikakulam (IN); Rajesh Kumar Singh, Bokaro Steel City Jharkhand (IN)

(73) Assignee: ANI Technologies Private Limited

(21) Appl. No.: 15/925,253

(22) Filed: Mar. 19, 2018

(30) Foreign Application Priority Data
Dec. 7, 2017 (IN) 201741043832

(51) Int. Cl. G06Q 30/02; G06Q 50/30

(52) U.S. Cl. CPC G06Q 30/0224; G06Q 50/30; G06Q 30/0226; G06Q 30/0202

(57) ABSTRACT

A method and a system for optimizing customer engagement in a transportation service is provided. One or more regular time intervals of travel by a customer are identified based on historical travel data of the customer. Regular travel data is detected from the historical travel data based on the one or more regular time intervals, and random travel data is detected based on the regular travel data and the historical travel data. Further, regular and random capacities of the customer are determined based on the regular and random travel data, respectively. A life-time value (LTV) of the customer is determined based on at least the regular and random capacities of the customer. Based on at least the determined LTV, targeted content is recommended to the customer that optimizes the customer engagement with the transportation service.

### CROSS-RELATED APPLICATIONS

This application claims priority of Indian Application Serial No. 201741043832, filed Dec. 7, 2017, the contents of which are incorporated herein by reference.

### FIELD OF THE INVENTION

The present invention relates generally to the field of transportation services, and more particularly, to a method and a system for optimizing customer engagement in a transportation service.

### BACKGROUND

Travel services, in particular on-demand cab services, have to optimize their revenues by balancing demands from customers and supply of the available vehicles for providing efficient services to the customers. Generally, vehicles are booked either on an individual basis or on shared basis. On individual basis, a customer or a small group of customers traveling towards the same destination book a vehicle, whereas on shared basis, multiple customers share the vehicle to reach their respective destinations.

With improvements in lifestyle of the customers and limited alternatives of public or private transportations, popularity of the cab services is continuously increasing. With increased demand for the cab services, various cab service providers have come into the market to provide the cab services to the customers. The cab service providers try to entice the customers with various offers, which may attract the customers to use their respective cab services. With such a healthy competition among the cab service providers, the customers are bound to split. Further, the customers are cost conscious and tend to select a cab service provider that charges the least for the cab service. In such a case, the customer may be ready to compromise on comfort level during the ride. However, from the perspective of the cab service provider, it is essential to retain the customers who may have used their cab services, and also attract the new customers. The retention of the old customers and attracting the new customers may motivate the cab service provider to continue providing the cab services to the customers. Therefore, the cab service provider may wish to engage the customers (i.e., the existing, left-over, or new customers) for a longer duration of time, which in turn can enhance their business opportunity and optimize the overall revenue.

In light of the foregoing, there exists a need for a technical and more reliable solution that solves the above mentioned problems and optimizes the customer engagement with the cab service provider.

### SUMMARY

In an embodiment of the present invention, a method for optimizing customer engagement in a transportation service is provided. Historical travel data of a customer is extracted from a database server over a first communication network. One or more regular time intervals of travel by the customer are identified based on the extracted historical travel data. The one or more regular time intervals are identified by means of a density-based spatial clustering of applications with noise (DBSCAN) technique. Regular and random travel data of the customer are detected from the extracted historical travel data, based on the one or more regular time intervals. Regular and random capacities of the customer are determined based on the regular and random travel data, respectively. A life-time value (LTV) of the customer is determined based on at least the determined regular and random capacities. Targeted content is recommended to the customer by way of transmitting the targeted content to a customer-computing device of the customer over a second communication network. The targeted content is determined based on at least the determined LTV to optimize the customer engagement.

In another embodiment of the present invention, a system for optimizing customer engagement in a transportation service is provided. The system comprises circuitry that is configured to perform method as described in the foregoing. The circuitry is configured to extract historical travel data of a customer from a database server over a first communication network. The circuitry is further configured to determine weekday and weekend travel data from the extracted historical travel data. The weekday and weekend travel data are determined based on a timestamp associated with each travel data in the extracted historical travel data. The circuitry is further configured to group the weekday and weekend travel data on to a first defined timeline in a week-wise manner to identify dense time intervals by means of a density-based spatial clustering of applications with noise (DBSCAN) technique. The circuitry is further configured to identify one or more regular time intervals of travel by the customer from the identified dense time intervals. The one or more regular time intervals are identified from the identified dense time intervals based on at least one of an age of a dense time interval, a conversion rate, or a count of demand or booking in the dense time interval. The circuitry is further configured to detect regular and random travel data of the customer from the extracted historical travel data. The regular and random travel data are detected based on the one or more regular time intervals.

The circuitry is further configured to determine regular and random capacities of the customer based on the regular and random travel data, respectively. The regular capacity is determined based on estimated values of a pick-up location, a drop-off location, a fare, and a travel distance associated with each travel data in the regular travel data. The random capacity is determined based on a weighted mean of estimated values of the random travel data with and without recency. The random capacity without recency is determined based on a gaussian kernel weighted estimated mean of the random travel data. The random capacity with recency is determined based on recent travel data associated with a second defined timeline.

The circuitry is further configured to determine an engagement level of the customer based on at least the regular and random capacities and a realized demand. Based on the engagement level of the customer, the circuitry is further configured to determine a life-time value (LTV) of the customer. The circuitry is further configured to rank customers based on at least one of the regular capacity, the random capacity, the LTV, or the engagement level of each of the customers. The customers are ranked to identify high, medium, or low risk customers. The circuitry is further configured to recommend targeted content to the customers based on at least the determined LTV to optimize the customer engagement. For example, the targeted content is recommended to the customers based on the ranking of the customers. Thus, the method and the system of the present invention provide at least one of the capacities, the LTV, or the engagement level of the customers in different time intervals. The capacities, the LTV, or the engagement level of the customers can be utilized to send real-time notifications to the customers for better utilization and engagement of the customers with the transportation service. Further, the capacities, the LTV, or the engagement level of the customers can be utilized to identify current states of the customers, and the targeted content can be recommended to the customers based on their current states, such as engaged, at risk, active, or inactive, to optimize the customer engagement with the transportation service.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice-versa.

FIG. 1 is a block diagram that illustrates an environment for optimizing customer engagement in a transportation service, in accordance with an embodiment of the present invention;

FIG. 2 is a block diagram that illustrates an application server of FIG. 1, in accordance with an embodiment of the present invention; and

FIGS. 3A and 3B, collectively, is a flow chart that illustrates a method for optimizing customer engagement in a transportation service, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” include plural references unless the context clearly dictates otherwise. For example, the term “an article” may include a plurality of articles unless the context clearly dictates otherwise. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components, which constitutes systems and methods for optimizing customer engagement in a transportation service. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

A transportation service is a service in which a vehicle is provided to a customer to transit between a plurality of locations including source and destination locations specified by the customer. The vehicle is a means of transport that is deployed by a transport provider to provide the transportation service, such as an on-demand cab service, to the customer. For example, the vehicle may be an automobile, a bus, a car, a bike, and the like. Hereinafter, various methods of optimizing the customer engagement in the transportation service have been described that will become apparent to a person having ordinary skill in the relevant art.

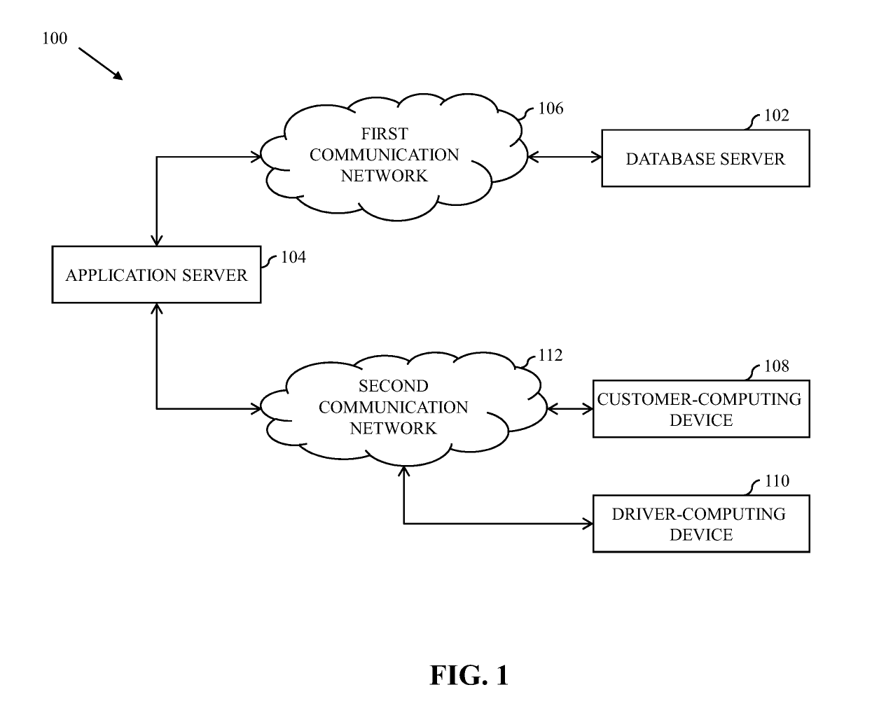

Referring now to FIG. 1, a block diagram that illustrates an environment 100 for optimizing customer engagement in a transportation service, in accordance with an embodiment of the present invention is shown. The environment 100 includes a database server 102 and an application server 104 that are connected to each other by way of a first communication network 106. Examples of the first communication network 106 include, but are not limited to, a wireless fidelity (Wi-Fi) network, a light fidelity (Li-Fi) network, a satellite network, an Internet, a mobile network such as cellular data, high speed packet access (HSPA), or any combination thereof. The environment 100 further includes a customer-computing device 108 and a driver-computing device 110 that are connected to the application server 104 by way of a second communication network 112. Examples of the second communication network 112 include, but are not limited to, a Wi-Fi network, a Li-Fi network, a satellite network, an Internet, a mobile network such as cellular data, HSPA, or any combination thereof. In an exemplary embodiment, the environment 100 may include a single communication network, such as the first or the second communication network 106 or 112. In such a scenario, the database server 102, the application server 104, the customer-computing device 108, and the driver-computing device 110 may communicate with each other by way of the first or second communication network 106 or 112.

The database server 102 is a data management and storage server that includes a processor (not shown) and a memory (not shown) for managing and storing historical travel data of one or more customers. The historical travel data of the one or more customers includes travel data of one or more rides that had been taken by the one or more customers in the past. In an exemplary embodiment, the historical travel data of a customer may include at least one of a pick-up location, a drop-off location, a pick-up time, a drop-off time, a ride fare, or a travel distance of the rides availed by the customer. The processor of the database server 102 receives and stores at least one of the pick-up location, the drop-off location, the pick-up time, the drop-off time, the ride fare, or the travel distance of the availed rides from the memory of the database server 102. In an embodiment, the historical travel data of the customer is stored in a tabular data structure in the database server 102. The tabular data structure may include one or more rows and one or more columns. The one or more columns may indicate time-wise pattern of travel by the customer, for example, day-wise, week-wise, month-wise, or the like. The one or more rows may indicate the historical travel related information of the customer associated with each time-wise pattern. The database server 102 further manages and stores customer information of the one or more customers (who had requested for the one or more rides) and driver information of one or more drivers (who had been selected for providing services to the one or more customers corresponding to the one or more rides). In an exemplary embodiment, the customer information of the customer may include at least a name, a contact number, or a customer account of the customer registered with the transportation service. Similarly, the driver information of a driver may include at least a name, a registered vehicle, or a driver account of the driver registered with the transportation service. In an embodiment, the database server 102 may receive a query from the application server 104 over the first communication network 106 to provide the historical travel data of the customer. In response to the received query, the database server 102 retrieves and provides the historical travel data of the customer to the application server 104 over the first communication network 106. Examples of the database server 102 include, but are not limited to, a personal computer, a laptop, or a network of computer systems.

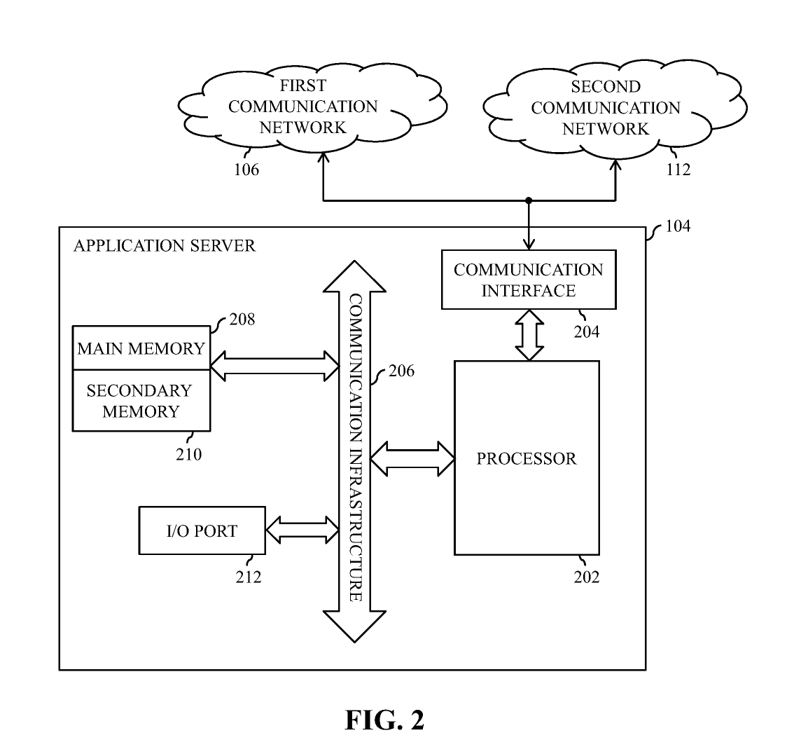

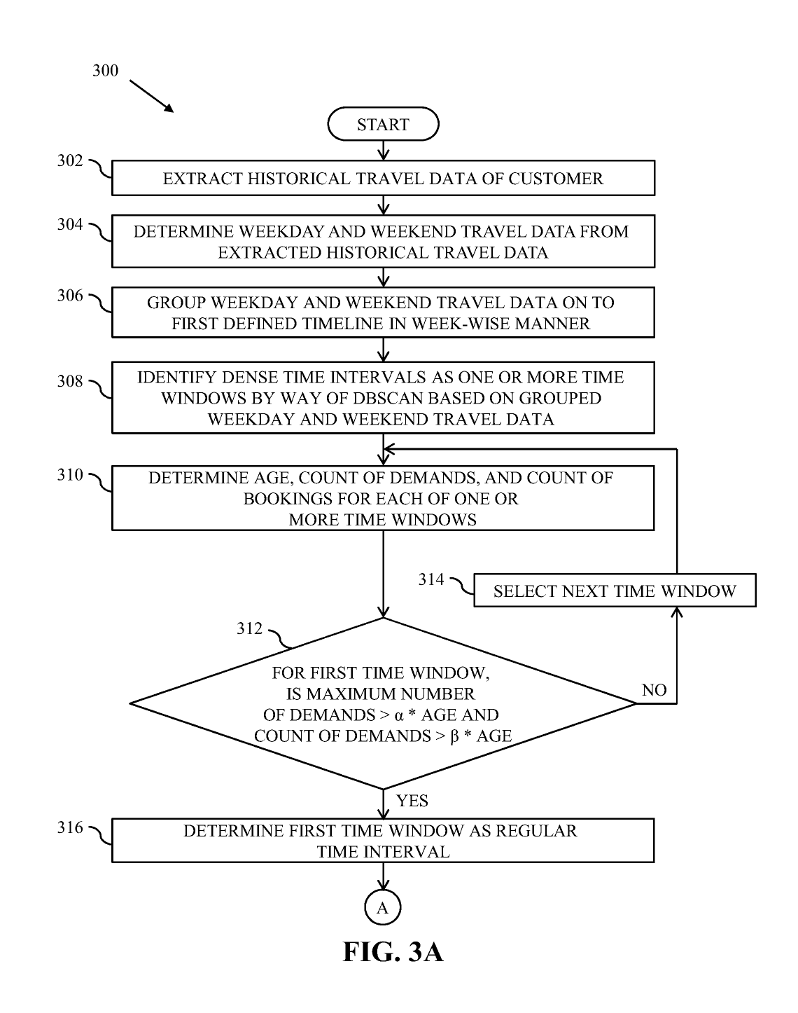

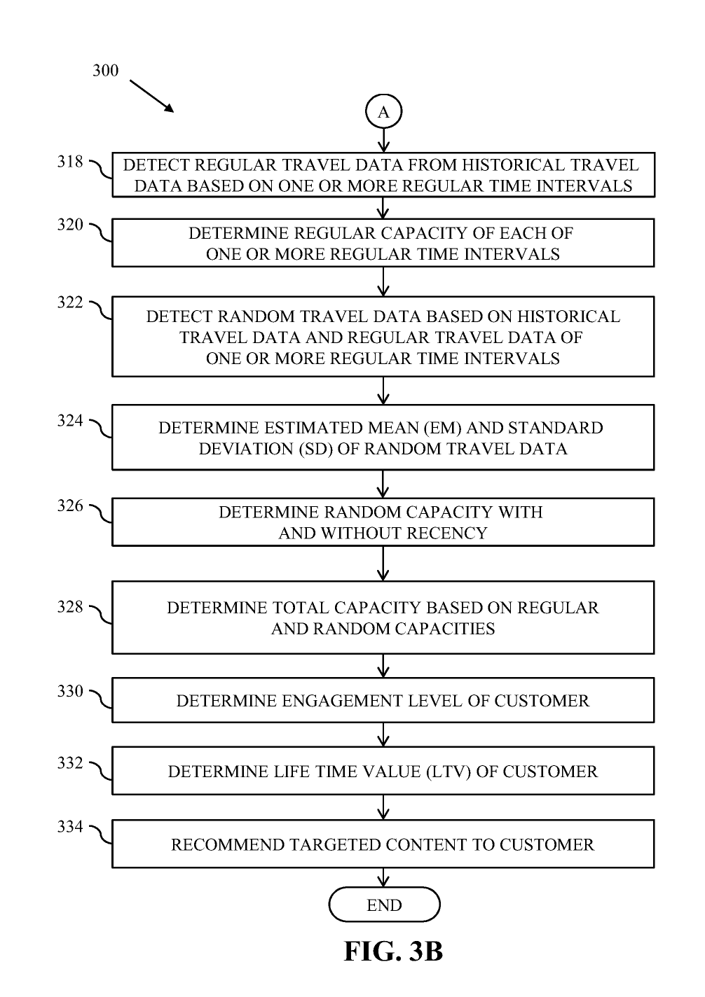

The application server 104 is a computing device, a software framework, or a combination thereof, that may provide a generalized approach to create the application server implementation. In an embodiment, the operation of the application server 104 may be dedicated to execution of procedures, such as, but are not limited to, programs, routines, or scripts stored in one or more memories for supporting its applied applications. In an embodiment, the application server 104 processes the historical travel data extracted from the database server 102. Based on the processing of the extracted historical travel data, the application server 104 identifies one or more regular time intervals of travel by the customer. In an exemplary embodiment, the application server 104 may be configured to execute a density-based spatial clustering of applications with noise (DBSCAN) technique to identify the one or more regular time intervals. Further, the application server 104 detects regular and random travel data of the customer from the extracted historical travel data based on the one or more regular time intervals. Further, in an embodiment, the application server 104 is configured to determine regular and random capacities of the customer based on the regular and random travel data, respectively. The application server 104 further determines an engagement level of the customer based on at least the regular and random capacities. Based on the engagement level of the customer, the application server 104 determines a life-time value (LTV) of the customer. Further, in an embodiment, the application server 104 determines a current state (e.g., engaged, lost, active, or inactive) of the customer based on at least one of the regular and random capacities, engagement level, or the LTV of the customer. Based on the current state of the customer, the application server 104 recommends targeted content to the customer that optimizes the customer engagement with the transportation service. The targeted content may include one or more offers or discounts related to ride fares for the future rides or entertainment-related content, such as movies, music, and the like. The application server 104 may be realized through various web-based technologies such as, but not limited to, a Java web-framework, a .NET framework, a PHP framework, or any other web-application framework. Examples of the application server 104 include, but are not limited to, a personal computer, a laptop, or a network of computer systems. Various operations of the application server 104 have been described in detail in conjunction with FIGS. 2, 3A, and 3B.

The customer-computing device 108 is a computing device that is utilized by the customer to perform one or more activities. For example, the customer utilizes the customer-computing device 108 to schedule a ride between a plurality of locations including source and destination locations. To schedule the ride, the customer uses the customer-computing device 108 to transmit a ride request for the ride by means of a service application installed on the customer-computing device 108. The ride request includes ride-related information, for example, a pick-up location, a drop-off location, a waiting time, a vehicle type, or other service-related details and preferences. In a scenario when the pick-up location of the customer is the same as the source location, the passenger may not provide the pick-up location. In such scenario, the pick-up location is automatically captured by the application server 104 based on Global Positioning System (GPS) information transmitted by the customer-computing device 108 over the second communication network 112. However, if the pick-up location is different from the captured source location, the customer may provide the pick-up location. The various modes of the input used by the customer may include, but are not limited to, a touch-based input, a text-based input, a voice-based input, a gesture-based input, or a combination thereof. Based on a confirmation of the ride request provided by the customer, the customer-computing device 108 transmits the ride request to the application server 104 over the second communication network 112. Examples of the customer-computing device 108 include, but are not limited to, a personal computer, a laptop, a smartphone, a tablet computer, a personal digital assistant (PDA), and the like.

The driver-computing device 110 is a computing device that is used by the driver to perform one or more activities. For example, the driver uses the driver-computing device 110 to view an upcoming ride request from the customer. The driver further uses the driver-computing device 110 to accept or reject the upcoming ride request. Based on the acceptance of the ride request by the driver, the application server 104 allocates the ride request to the driver. The driver further uses the driver-computing device 110 to view a route between the pick-up and drop-off locations provided by the application server 104 over the second communication network 112. The various modes of the input used by the driver may include, but are not limited to, a touch-based input, a text-based input, a voice-based input, a gesture-based input, or a combination thereof. In an exemplary embodiment, the driver-computing device 110 may be a vehicle head unit. In another exemplary embodiment, the driver-computing device 110 may be an external communication device, such as a smartphone, a PDA, a tablet computer, a laptop, or any other portable communication device, that is placed inside the vehicle of the driver.

Referring now to FIG. 2, a block diagram that illustrates the application server 104 of FIG. 1, in accordance with an embodiment of the present invention is shown. An embodiment of present invention, or portions thereof, may be implemented as computer readable code on the application server 104. In one example, the application server 104 may be implemented using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A and 3B. The application server 104 includes a processor 202, a communication interface 204, communication infrastructure 206, a main memory 208, a secondary memory 210, and an input/output (I/O) port 212.

The processor 202 includes suitable logic, circuitry, and/or interfaces that are operable to execute one or more instructions stored in at least one of the main and secondary memories 208 and 210 to perform one or more operations. The processor 202 may be a special purpose or a general purpose processing device. The processor 202 may be a single processor, multiple processors, or combinations thereof. The processor 202 may have one or more processor “cores”. Further, the processor 202 may be connected to the communication infrastructure 206, such as a bus, a bridge, a message queue, the first and second communication networks 1-6 and 112, multi-core message-passing scheme, and the like. Examples of the processor 202 include an application-specific integrated circuit (ASIC) processor, a reduced instruction set computing (RISC) processor, a complex instruction set computing (CISC) processor, a field-programmable gate array (FPGA), and the like. The processor 202 may be connected to the communication interface 204 for receiving and transmitting information (e.g., the historical travel data, the ride request, the targeted content, and the like) from the database server 102, the customer-computing device 108, and the driver-computing device 110 over at least one of the first or second communication network 106 or 112.

The communication interface 204 includes suitable logic, circuitry, and/or interfaces that are operable to execute one or more instructions stored in at least one of the main and secondary memories 208 and 210 to perform one or more operations. The communication interface 204 may be configured to communicate with at least one of the first or second communication network 106 or 112 to receive and transmit the information from the database server 102, the customer-computing device 108, and the driver-computing device 110 that are communicatively coupled to the application server 104. Examples of the communication interface 204 may include a modem, a network interface, i.e., an Ethernet card, a communications port, and the like. The information transferred via the communication interface 204 may be signals, such as electronic, electromagnetic, optical, or other signals as will be apparent to a person skilled in the art. The signals may travel via a communications channel, such as the first or second communication network 106 or 112. Examples of the communication channel may include, but are not limited to, cable, fiber optics, a phone line, a cellular phone link, a radio frequency link, a wireless link, and the like.

The communication infrastructure 206 includes suitable logic, circuitry, and/or interfaces that are operable to execute one or more instructions stored in at least one of the main and secondary memories 208 and 210 to perform one or more operations. The communication infrastructure 206 may be a bus, a bridge, a message queue, multi-core message-passing scheme, and the like. Further, the processor 202 may be connected to the communication infrastructure 206. The processor 202, the main memory 208, the secondary memory 210, and the I/O port 212 may communicate with each other by way of the communication infrastructure 206.

The main memory 208 includes suitable logic, circuitry, and/or interfaces to store the one or more instructions that are executed by the processor 202 to perform the one or more operations. The main memory 208 may further store one or more algorithms, procedures, codes, and the like that are executed by the processor 202 to perform the one or more operations. For example, the processor 202 may execute the one or more instructions, algorithms, procedures, codes, and the like stored in the main memory 208 to process the extracted historical travel data, identify the one or more regular time intervals, detect the regular and random travel data from the historical travel data, and determine the regular and random capacities, engagement level, and the LTV of the customer. Examples of the main memory 208 include a random access memory (RAM), a read-only memory (ROM), a programmable ROM (PROM), an erasable PROM (EPROM), a Hard Disk Drive (HDD), and a Secure Digital (SD) card, and the like. In an embodiment, the main memory 208 is connected the secondary memory 210. The secondary memory 210 may be configured to temporarily store the extracted historical travel data, the ride request, the targeted content, and the like. The secondary memory 210 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The I/O port 212 includes suitable logic, circuitry, and/or interfaces that are operable to execute one or more instructions stored in at least one of the main and secondary memories 208 and 210 to perform one or more operations. The I/O port 212 may include various input and output devices that are configured to operate under the control of the processor 202 by way of the communication infrastructure 206. Examples of the input devices may include a keyboard, a mouse, a joystick, a touchscreen, a microphone, and the like. Examples of the output devices may include a display screen, a speaker, headphones, and the like. Examples of the I/O port 212 include a universal serial bus (USB) port, an Ethernet port, a real or virtual keypad, a mouse, a stylus, and the like. The various operations of the application server 104 have been described in detail in conjunction with FIGS. 3A and 3B.

Referring now to FIGS. 3A and 3B, a flow chart 300 that illustrates a method for optimizing the customer engagement in the transportation service, in accordance with an embodiment of the present invention is shown. At step 302, the historical travel data of the customer is extracted. The processor 202 extracts the historical travel data of the customer from the database server 102 over the first communication network 106. The historical travel data includes the travel data of the one or more rides availed by the customer in the past. The historical travel data may include at least one of the pick-up location, the drop-off location, the pick-up time, the drop-off time, the ride fare, or the travel distance of the one or more rides by the customer. The processor 202 stores the extracted historical travel data of the customer in at least one of the main or secondary memory 208 or 210.

At step 304, weekday and weekend travel data are determined from the extracted historical travel data. The processor 202 determines the weekday and weekend travel data from the extracted historical travel data based on a timestamp associated with each travel data (i.e., each of the one or more rides) in the extracted historical travel data. The timestamp may be at least one of the pick-up or drop-off time associated with each of the one or more rides. The weekday travel data is the travel data associated with one or more weekdays (for example, “Monday”, “Tuesday”, “Wednesday”, “Thursday” or “Friday”) of one or more weeks. The weekend travel data is the travel data associated with one or more weekend days (for example, “Saturday” or “Sunday”) of the one or more weeks.

At step 306, the weekday and weekend travel data are grouped on to a first defined timeline in a week-wise manner. The processor 202 groups the weekday and weekend travel data on to the first defined timeline. For example, the weekday and weekend travel data are separately grouped in the week-wise manner on to a weekly grid.

At step 308, dense time intervals are identified by way of the DBSCAN technique based on at least one of the grouped weekday and weekend travel data. For example, the processor 202 executes the one or more instructions, algorithms, codes, or routines corresponding to the DBSCAN technique stored in the main memory 208, and identifies one or more dense time intervals from the grouped weekday travel data. Similarly, the processor 202 identifies the one or more dense time intervals from the grouped weekend travel data. The one or more dense time intervals are one or more time windows in which the one or more rides were taken by the customer. The one or more time windows may be associated with one or more days (e.g., weekdays or weekend days). Further, in an embodiment, the processor 202 identifies the one or more regular time intervals from each of the one or more time windows corresponding to the weekday (and/or weekend) travel data. The identification of the one or more regular time intervals has been described in steps 310-316.

At step 310, at least one of an age (A), a count of bookings (B), a conversion rate (C), a count of demands (D) in each time window of the one or more time windows is determined. The processor 202 determines at least one of the age (A), the count of bookings (B), the conversion rate (C), or the count of demands (D) in each of the one or more time windows. The age (A) of a time window (i.e., an identified dense time interval) is a current time length from a current time instance to a historical time instance of the time window. The count of bookings (B) in the time window is a number of rides taken by the customer during the time window. The conversion rate (C) of the time window is a ratio of the count of bookings and the count of demands in the time window. The count of demands (D) in the time window is a number of requests for the one or more rides received from the customer-computing device 108 in the time window. In an embodiment, the processor 202 determines at least one of the age (A), the count of bookings (B), the conversion rate (C), or the count of demands (D) based on the travel data associated with the time window. The processor 202 further determines the one or more days in the time window. Further, the processor 202 determines a maximum number of demands (Dmax) corresponding to a day from the one or more days of the time window. The processor 202 further determines the count of days (D) for each of the remaining days of the one or more days in the time window.

At step 312, a check is performed for a first time window from the one or more time windows to determine whether the maximum number of demands (Dmax) in the first time window is greater than a first threshold value and the count of demands (D) for each of the remaining days is greater than a second threshold value. In an embodiment, the first threshold value is determined based on the age (A) of the first time window and a first factor (a). For example, the first threshold value may be determined based on a product of the first factor (a) and the age (A) of the first time window. In an exemplary embodiment, a value of the first factor (a) is 0.2. In an embodiment, the second threshold value is determined based on the age (A) of the first time window and a second factor (β). For example, the second threshold value may be determined based on a product of the second factor (β) and the age (A) of the first time window. In an exemplary embodiment, a value of the second factor (β) is 0.15. In an embodiment, the processor 202 utilizes the conversion rate (C) to remove the one or more customers having low bookings. For example, if the conversion rate (C) of the customer is less than a cut-off conversion value, then the processor 202 may not consider the customer for the customer engagement. If at step 312, for the first time window, it is determined that the maximum number of demands (Dmax) is greater than the first threshold value and the count of demands (D) for each of the remaining days is greater than the second threshold value, then step 316 is executed. However, if at step 312, it is determined that the maximum number of demands (Dmax) is less than the first threshold value and the count of demands (D) for each of the remaining days is greater (or less) than the second threshold value, or vice-versa, then the first time window is not identified as a regular time interval, and step 314 is executed.

At step 314, a next time window i.e., a second time window is selected from the one or more time windows, and the steps 310 and 312 are executed for the second time window. At step 316, the first time window, for which the maximum number of demands (Dmax) is greater than the first threshold value and the count of demands (D) for each of the remaining days is greater than the second threshold value, is determined as the regular time interval. Similarly, the processor 202 checks the remaining time windows, if any, of the one or more time windows to determine remaining regular time intervals. Thus, before proceeding to step 318, the processor 202 determines the one or more regular time intervals. In an embodiment, based on the execution of the steps 310, 312, and 314, as described above with respect to the first time window, the processor 202 determines the one or more regular time intervals from the one or more time windows (i.e., the one or more dense time intervals).

At step 318, the regular travel data is detected from the historical travel data for the one or more regular time intervals. For each of the one or more regular time intervals, the processor 202 detects the regular travel data from the historical travel data based on each of the one or more regular time intervals, and stores the regular travel data in at least one of the main or secondary memory 208 or 210.

At step 320, the regular capacity for each of the one or more regular time intervals is determined. The processor 202 determines the regular capacity for each of the one or more regular time intervals based on the corresponding regular travel data, and stores in at least one of the main or secondary memory 208 or 210. In an exemplary embodiment, the regular capacity for each regular time interval is determined based on estimated values of at least one of the pick-up location, the drop-off location, the ride fare, or the travel distance associated with the one or more rides in the regular travel data of the corresponding regular time interval. In another exemplary embodiment, the regular capacity for each regular time interval is determined based on at least one of an average distance of the one or more rides, the count of bookings (B), or an average ride fare of the one or more rides in the regular travel data of the corresponding regular time interval.

At step 322, the random travel data is detected based on the historical travel data and the regular travel data of the one or more regular time intervals. The processor 202 detects the random travel data by filtering out the regular travel data of the one or more regular time intervals from the historical travel data.

At step 324, an estimated mean (EM) and a standard deviation (SD) of the random travel data are determined. The random travel data are grouped based on a week number (W(n)) to obtain a number of rides in each week. The processor 202 groups the random travel data based on the week number (W(n)) in which the one or more rides were taken by the customer. The estimated mean (EM) is an estimate mean of the random travel data using Gaussian kernel weights.

At step 326, the random capacity with and without recency is determined. In an embodiment, the processor 202 determines the random capacity without recency based on the determined estimated mean (EM) and the determined standard deviation (SD) of the random travel data. The processor 202 further determines the random capacity with recency based on recent travel data associated with a second defined timeline. For example, the random capacity with recency is determined based on a previous week random capacity and the age (A) of a previous week. The random capacity for the previous week is multiplied by a coefficient, based on the age of the previous week. The value of the coefficient reduces with increase in the value of the week number (W(n)), thereby, weights of the previous random capacities is reduced for the grouped random travel data with increasing week number. In an exemplary embodiment, the determination of the random capacity is given by the equation (1):

RC(n)=a*(EM+SD)+b*RC(n−1)+c*w(n−1) (1)

In the equation (1), a, b, and c are coefficients that are obtained from regression on specifically chosen data set, w(n−1) is a number of random travels in a week (n−1). Further, “a*(EM+SD)” in the equation (1) indicates the estimation based on total random history and “b*RC(n−1)+c*w(n−1)” in the equation (1) indicates the random capacity considering the recency. Further, “RC(n)” is the random capacity in the nth week with and without recency.

At step 328, a total capacity of the customer is determined. The processor 202 determines the total capacity based on the random and regular capacities of the customer. The total capacity of the customer is determined by executing an algebraic summation of the random and regular capacities of the customer. The regular capacity of the customer is determined by executing one or more algebraic operations (e.g., a summation, a mean, an average, a median, or a standard deviation) on one or more regular capacities corresponding to the one or more regular time intervals.

At step 330, the engagement level of the customer is determined. The processor 202 determines the engagement level of the customer based on the total capacity of the customer and a realized demand. The engagement level is defined as a ratio of the realized demand and the total capacity of the customer. For example, the engagement level of the customer in the week (W(n)) is the ratio of demands in the week (W(n)) and the total capacity of the customer in the previous week (W(n−1)). The engagement level may be utilized to determine whether the customer is deviated from a mean engagement. For example, based on the engagement level of the customer in the one or more weeks, the processor 202 obtains an engagement pattern of the customer, and determines an engagement state of the customer (e.g., engaged, disengaged, new, or lost) based on the deviation of the engagement pattern from the mean engagement.

At step 332, the LTV of the customer is determined. The processor 202 determines the LTV of the customer based on at least the engagement level of the customer. In an exemplary embodiment, the LTV of the customer may be determined based on at least an expected value of the engagement level (E1), an expected value of the conversion rate (E2), and the regular capacity (RegCap) and random capacity (RanCap). The determination of the LTV of the customer is given by the equation (2):

LTV=(ΣATS of Regular interval+RanCap*E[ATS])*(E[1])*(E[2]) (2)

At step 334, the targeted content is recommended to the customer. Based on the determined LTC of the customer, the processor 202 recommends the targeted content to the customer. The targeted content may also be recommended based on the total capacity or the engagement level of the customer. The processor 202 transmits the targeted content to the customer-computing device 108 of the customer over the second communication network 112. The targeted content includes one or more offers or discounts that matches with the interests of the customer. The one or more offers or discounts may be related to one or more ride fares for one or more future rides. The one or more offers or discounts may be further related to entertainment-related content, such as movies, music, and the like. Such recommendation of the targeted content encourages the customer to use the transportation service (e.g., cab service), which in turn optimizes the customer engagement with the transportation service. Furthermore, the processor 202 ranks the customers based on at least one of the regular capacity, random capacity, LTV, or engagement level of each of the customers. The ranking of the customers can be further utilized to identify high, medium, or low risk customers. The recommendation of the targeted content can be decided by the processor 202 based on the risk associated with the customers.

Specific advantages of the method and the system include determining the LTV of the customers in the transportation service, such as the cab service. The method further includes determining regular and random travel patterns and engagement patterns of the customers over one or more previous weeks, months, or years. Based on at least one of the regular and random travel patterns, the engagement patterns, and the LTV of the customers, the current state (e.g., engaged, disengaged, lost, or new) and the risk (e.g., high, medium, or low) of each of the customers is identified. Further, based on at least one of the current state and the risk associated with each customer, the processor 202 recommends the targeted content to the customers. The recommendation of the targeted content to the customers improves the engagement of the customers with the transportation service and thus, helps in retaining the customers. Thus, the method and the system provide an efficient way of optimizing the customer engagement.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 202, and a memory, such as the main memory 208 and the secondary memory 210, implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present invention provide, among other features, systems and methods for optimizing customer engagement in a transportation service. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

What is claimed is:

1. A method for optimizing customer engagement in a transportation service, the method comprising:
extracting, by circuitry, historical travel data of a customer from a database server over a first communication network;
identifying, by the circuitry, one or more regular time intervals of travel by the customer based on the extracted historical travel data by means of a density-based spatial clustering of applications with noise (DBSCAN) technique;
detecting, by the circuitry, regular and random travel data of the customer from the extracted historical travel data based on the one or more regular time intervals;
determining, by the circuitry, regular and random capacities of the customer based on the regular and random travel data, respectively;
determining, by the circuitry, a life-time value (LTV) of the customer based on at least the determined regular and random capacities; and
recommending, by the circuitry, targeted content to the customer by way of transmitting the targeted content to a customer-computing device of the customer over a second communication network, based on at least the determined LTV to optimize the customer engagement.

2. The method of claim 1, further comprising determining, by the circuitry, weekday and weekend travel data from the extracted historical travel data based on a timestamp associated with each travel in the historical travel data.

3. The method of claim 2, further comprising grouping, by the circuitry, the weekday and weekend travel data on to a defined timeline in a week-wise manner to identify dense time intervals by means of the DBSCAN technique.

4. The method of claim 3, wherein the one or more regular time intervals are identified from the identified dense time intervals based on at least one of an age of a dense time interval, a conversion rate, or a count of demand or booking in the dense time interval.

5. The method of claim 1, wherein the regular capacity is determined based on estimated values of a pick-up location, a drop-off location, a fare, and a travel distance associated with each travel in the regular travel data.

6. The method of claim 1, wherein the random capacity is determined based on a weighted mean of estimated values of the random travel data with and without recency.

7. The method of claim 6, wherein the random capacity without recency is determined based on a gaussian kernel weighted estimated mean of the random travel data, and wherein the random capacity with recency is determined based on recent travel data associated with a defined timeline.

8. The method of claim 1, further comprising determining, by the circuitry, an engagement level of the customer based on at least the regular and random capacities and a realized demand.

9. The method claim 8, wherein the LTV of the customer is further determined based on the engagement level of the customer.

10. The method of claim 1, further comprising ranking, by the circuitry, customers based on at least one of the regular capacity, the random capacity, the LTV, or an engagement level of each of the customers, wherein the ranking of the customers is utilized to identify high, medium, or low risk customers.

11. The method of claim 1, wherein the historical travel data of the customer is stored in a tabular data structure in the database server.

12. A system for optimizing customer engagement in a transportation service, the system comprising:
circuitry configured to:
extract, from a database server over a first communication network, historical travel data of a customer;
identify, by means of a density-based spatial clustering of applications with noise (DBSCAN) technique, one or more regular time intervals of travel by the customer based on the extracted historical travel data;
detect, from the extracted historical travel data, regular and random travel data of the customer based on the one or more regular time intervals;
determine regular and random capacities of the customer based on the regular and random travel data, respectively;
determine a life-time value (LTV) of the customer based on at least the determined regular and random capacities; and
recommend targeted content to the customer by way of transmitting the targeted content to a customer-computing device of the customer over a second communication network, based on at least the determined LTV to optimize the customer engagement.

13. The system of claim 12, wherein the circuitry is further configured to determine weekday and weekend travel data from the extracted historical travel data based on a timestamp associated with each travel in the historical travel data.

14. The system of claim 13, wherein the circuitry is further configured to group the weekday and weekend travel data on to a defined timeline in a week-wise manner to identify dense time intervals by means of the DBSCAN technique.

15. The system of claim 14, wherein the circuitry is further configured to identify, from the identified dense time intervals, the one or more regular time intervals based on at least one of an age of a dense time interval, a conversion rate, a count of demand or booking in the dense time interval.

16. The system of claim 12, wherein the circuitry is further configured to determine regular capacity based on estimated values of a pick-up location, a drop-off location, a fare, and a travel distance associated with each travel in the regular travel data.

17. The system of claim 12, wherein the circuitry is further configured to determine the random capacity based on a weighted mean of estimated values of the random travel data with or without recency.

18. The system of claim 17, wherein the random capacity without recency is determined based on a gaussian kernel weighted estimated mean of the random travel data, and wherein the random capacity with recency is determined based on recent travel data associated with a defined timeline.

19. The system of claim 12, wherein the circuitry is further configured to determine an engagement level of the customer based on at least the regular and random capacities and a realized demand.

20. The system of claim 19, wherein the circuitry is configured to determine the LTV of the customer based on the engagement level of the customer, wherein customers are ranked based on at least one of the regular capacity, the random capacity, the LTV, or an engagement level of each of the customers, wherein the ranking of the customers is utilized to identify high, medium, or low risk customers, and wherein the ranking of the customers is utilized to optimize the customer engagement.
